(19) United States
(12) Patent Application Publication
(10) Pub. No.: US 2024/0061781 A1
(43) Pub. Date: Feb. 22, 2024

(54) DISAGGREGATED CACHE MEMORY FOR EFFICIENCY IN DISTRIBUTED DATABASES

(71) Applicant: Google LLC, Mountain View, CA (US)

(72) Inventors: John Fremlin, New York City, NY (US); Gabor Dinnyes, New York City, NY (US); Todd J. Lipcon, Menlo Park, CA (US); William Keith Funkhouser, III, Madison, WI (US)

(73) Assignee: Google LLC, Mountain View, CA (US)

(21) Appl. No.: 18/449,666

(22) Filed: Aug. 14, 2023

Related U.S. Application Data
(60) Provisional application No. 63/371,615, filed on Aug. 16, 2022.

(51) Int. Cl. G06F 12/084

(52) U.S. Cl. CPC G06F 12/084; G06F 2212/163

(57) ABSTRACT

A method for disaggregated cache memory for efficiency in distributed databases includes receiving, from a user device, a first query requesting first data be written to a distributed database. The distributed database includes a plurality of nodes each controlling writes to a respective portion of the distributed database and a distributed cache pool caching a subset of the distributed database independently from the plurality of nodes. The method includes writing, using one of the plurality of nodes, the first data to the distributed database. The method also includes receiving, from the user device, a second query requesting second data be read from the distributed database. The method further includes retrieving, from the distributed cache pool, the second data. The method includes providing, to the user device, the second data retrieved from the distributed cache pool.

### CROSS REFERENCE TO RELATED APPLICATIONS

This U.S. patent application claims priority under 35 U.S.C. § 119(e) to U.S. Provisional Application 63/371,615, filed on Aug. 16, 2022. The disclosure of this prior application is considered part of the disclosure of this application and is hereby incorporated by reference in its entirety.

### TECHNICAL FIELD

This disclosure relates to disaggregated cache memory for efficiency in distributed databases.

### BACKGROUND

Cloud computing has increased in popularity as storage of large quantities of data in the cloud becomes more common. One way to manage data in the cloud is through distributed databases, where multiple nodes (e.g., servers) in a computing cluster are implemented to handle the data. For a distributed database to operate without failure, each node must have sufficient resources (i.e., RAM) to perform even at peak intervals. Each node is provisioned for peak usage. That is, each node is provisioned with sufficient resources to handle peak load.

### SUMMARY

One aspect of the disclosure includes a method for providing disaggregated cache memory to increase efficiency in distributed databases. The method is executed by data processing hardware that causes the data processing hardware to perform operations that include receiving, from a user device, a first query requesting first data be written to a distributed database. The distributed database includes a plurality of nodes, each respective node of the plurality of nodes controlling writes to a respective portion of the distributed database and a distributed cache pool, the distributed cache pool caching a subset of the distributed database independently from the plurality of nodes. The operations include writing, using one of the plurality of nodes, the first data to the distributed database. The operations also include receiving, from the user device, a second query requesting second data be read from the distributed database. The operations include retrieving, from the distributed cache pool, the second data. The operations further include providing, to the user device, the second data retrieved from the distributed cache pool.

Implementations of the disclosure may include one or more of the following optional features. In some implementations, the distributed cache pool is distributed memory of a second plurality of nodes, each node in the second plurality of nodes different from each node in the plurality of nodes. In these implementations, the distributed cache pool may include a first portion distributed across random access memory (RAM) of the second plurality of nodes and a second portion distributed across solid state drives (SSDs) of the second plurality of nodes.

In some implementations, the operations further include generating an access map mapping locations of data in the distributed cache pool. In these implementations, the operations further include distributing the access map to each node of the plurality of nodes. In these implementations, after receiving the first query, the operations may further include determining, by at least one of the plurality of nodes, using the access map, the location of the first data in the distributed cache pool.

In some implementations, the operations further include generating an access map mapping locations of data in the distributed cache pool and distributing the access map to the user device. In these implementations, the second query may include a location of the second data in the distributed cache pool based on the access map.

Retrieving, from the distributed cache pool, the second data may be based on a hashmap mapping locations of data in the distributed cache pool. Alternatively, retrieving, from the distributed cache pool, the second data may include using a remote direct memory access. Further, the distributed cache pool may include row cache and block cache.

Another aspect of the disclosure provides a system for disaggregating cache memory in a distributed database. The system includes data processing hardware and memory hardware in communication with the data processing hardware. The memory hardware stores instructions that when executed on the data processing hardware cause the data processing hardware to perform operations. The operations include receiving, from a user device, a first query requesting first data be written to a distributed database. The distributed database includes a plurality of nodes, each respective node of the plurality of nodes controlling writes to a respective portion of the distributed database and a distributed cache pool, the distributed cache pool caching a subset of the distributed database independently from the plurality of nodes. The operations include writing, using one of the plurality of nodes, the first data to the distributed database. The operations also include receiving, from the user device, a second query requesting second data be read from the distributed database. The operations include retrieving, from the distributed cache pool, the second data. The operations further include providing, to the user device, the second data retrieved from the distributed cache pool.

This aspect may include one or more of the following optional features. In some implementations, the distributed cache pool is distributed memory of a second plurality of nodes, each node in the second plurality of nodes different from each node in the plurality of nodes. In these implementations, the distributed cache pool may include a first portion distributed across random access memory (RAM) of the second plurality of nodes and a second portion distributed across solid state drives (SSDs) of the second plurality of nodes.

In some implementations, the operations further include generating an access map mapping locations of data in the distributed cache pool. In these implementations, the operations further include distributing the access map to each node of the plurality of nodes. In these implementations, after receiving the first query, the operations may further include determining, by at least one of the plurality of nodes, using the access map, the location of the first data in the distributed cache pool.

In some implementations, the operations further include generating an access map mapping locations of data in the distributed cache pool and distributing the access map to the user device. In these implementations, the second query may include a location of the second data in the distributed cache pool based on the access map.

Retrieving, from the distributed cache pool, the second data may be based on a hashmap mapping locations of data in the distributed cache pool. Alternatively, retrieving, from the distributed cache pool, the second data may include using a remote direct memory access. Further, the distributed cache pool may include row cache and block cache.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for disaggregating cache memory in a distributed database.

FIG. 2A is a schematic view of a query for writing data to the distributed database.

FIG. 2B is a schematic view of a query for reading data from the distributed database.

FIG. 3 is a schematic view of an example distributed cache pool.

FIG. 4 a flowchart of an example arrangement of operations for a method for disaggregating cache memory in a distributed database.

FIG. 5 is a schematic view of an example computing device that may be used to implement the systems and methods described herein.

Like reference symbols in the various drawings indicate like elements.

### DETAILED DESCRIPTION

In a cloud computing environment, large collections of data may be organized in a distributed database architecture where the data is spread across hundreds if not thousands of different computing platforms (i.e., nodes or servers). One common distributed database architecture, known as “shared-nothing,” assigns each available node to a section (i.e., “shard”) of the distributed database, where the nodes are independent of one another and where the sections do not overlap. When a query is made to a shared-nothing distributed database, the system directs the query to the appropriate node based on the section of the database related to the query. One drawback to the shared-nothing distributed database is that one or more modes can be overloaded with queries at peak traffic intervals. To prevent a node from being overloaded, a shared-nothing distributed database architecture requires each node to be equipped with enough resources (e.g., cache memory) to handle peak volume. However, system traffic is usually well below peak volume, resulting in the nodes usually being significantly overprovisioned for the majority of traffic. Further, while each node may have varying cache needs, the system is provisioned uniformly, meaning that nodes with little volume are still provisioned to handle peak traffic for the busiest node. In turn, these shared-nothing distributed database architectures are expensive and inefficient due to the abundance of resources that are idle except during extreme circumstances.

Implementations herein are directed toward a system for disaggregating cache memory from nodes in distributed databases. In other words, instead of allocating a large amount of cache memory to each node, systems of the current disclosure implement a disaggregated cache (i.e., distributed cache pool) for caching the distributed database that is independent of the nodes, thus allowing each node to be allocated less individual cache memory, resulting in fewer resources used in the system overall. For example, instead of a distributed database system having 20 nodes with each node having 16 GB of cache memory, an example distributed database system of the current disclosure could have 20 nodes where each node is allocated only 4 GB of individual cache memory, but with each node having access to a 64 GB distributed cache pool. By implementing the distributed cache pool, the system uses fewer resources overall while still maintaining operability during peak traffic.

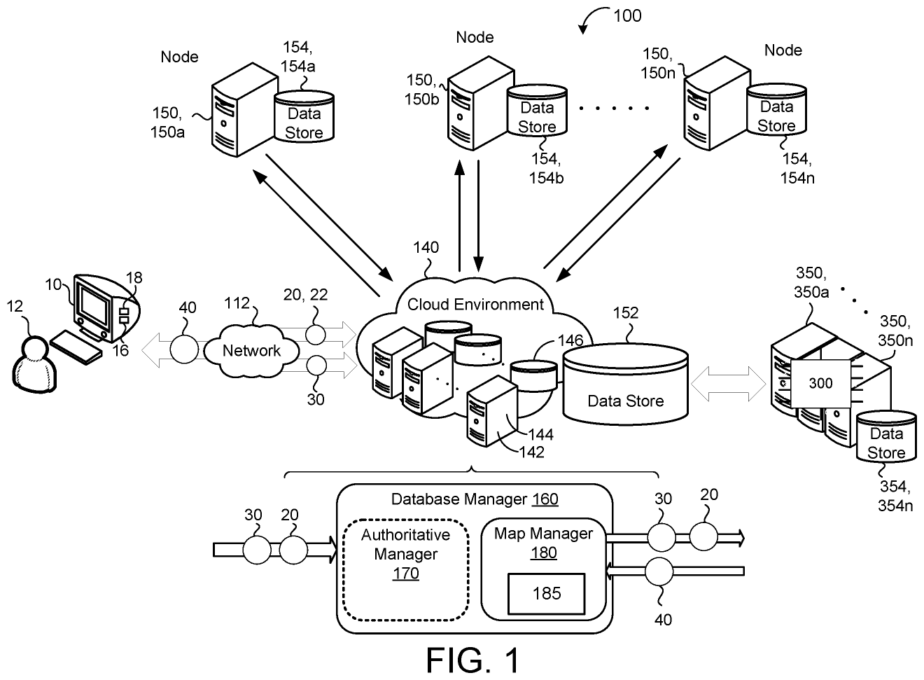

Referring now to FIG. 1, in some implementations, a disaggregated cache system 100 includes a remote system 140 in communication with one or more user devices 10 via a network 112. The remote system 140 may be multiple computers or a distributed system (e.g., a cloud environment) having scalable/elastic resources 142 including computing resources 144 (e.g., data processing hardware) and/or storage resources 146 (e.g., memory hardware). A data store 152 (i.e., a remote storage device) may be overlain on the storage resources 146 to allow scalable use of the storage resources 146 by one or more of the clients (e.g., the user device 10) or the computing resources 144. The data store 152 may include a distributed database storing a large amount of data. The term ‘distributed database’ may be used to reference the data store 152 throughout the disclosure.

The remote system 140 is configured to write queries 20 requesting data to be written to the database 152 and read queries 30 requesting data be read from the database 152. The queries 20, 30 may originate from a user device 10 associated with a respective user 12 and transmitted to the remote system 140 via, for example, a network 112. The user device 10 may correspond to any computing device, such as a desktop workstation, a laptop workstation, or a mobile device (i.e., a smart phone). The user device 10 includes computing resources 18 (e.g., data processing hardware) and/or storage resources 16 (e.g., memory hardware).

Writes to the database 152 are controlled by multiple nodes 150, 150a—n (also referred to herein as “servers” and/or “tablet servers”), with each node 150 responsible for a portion of the database 152 (e.g., defined by a key range). The distributed database 152 includes a distributed cache pool 300 implemented by multiple cache nodes 350, 350a—n. The cache nodes may be the same or different from the nodes 150. For example, the cache nodes 350 may include more cache (e.g., random access memory (RAM), etc.) than the nodes 150. The data store 152 may store any appropriate data for any number of users 12 at any point in time.

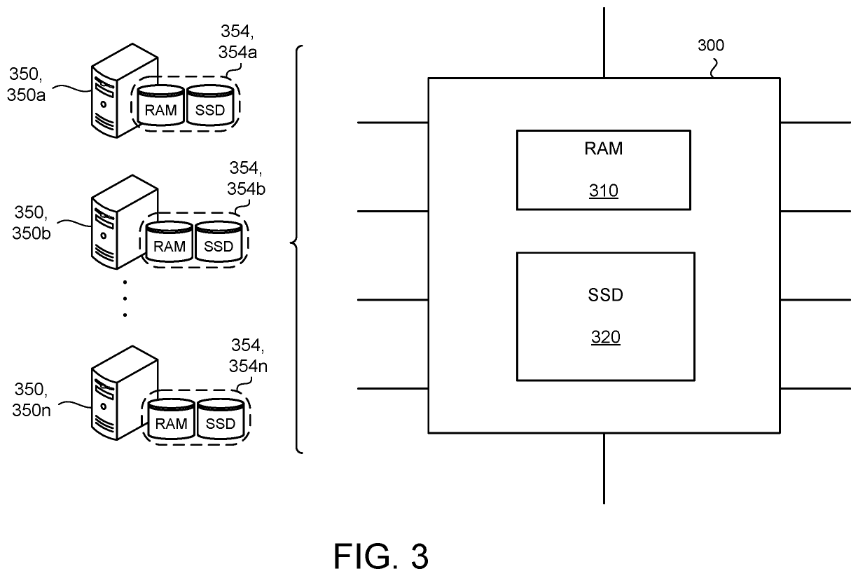

The distributed database 152 may be divided into sections (i.e., shards or slices) based on key ranges, where each section is assigned to a node 150, 350. Each node 150 maintains (i.e., has authoritative control over writes to) a corresponding portion (or shard) of the distributed database 152, which, when combined with the corresponding portions of the distributed database 152 of each other node 150, encompasses the entire distributed database 152. In a conventional database, each node 150 would supply the cache for the respective section or portion the node 150 governs. That is, each node 150 caches the most frequently or most recently accessed data from its shard or section using memory (e.g., RAM) of the respective node 150. In contrast to a conventional database, the distributed database 152 includes the distributed cache pool 300 sourced by cache nodes 350. The distributed cache pool 300 may be a large data store comprising different types or tiers of memory (such as a combination of RAM and solid-state drives (SSD)), as discussed in greater details below (FIG. 3). While the distributed cache pool 300, in some implementations, is accessible to nodes 150, the distributed cache pool 300 is disaggregated from the nodes 150 such that portions of the distributed cache pool 300 do not have to correspond to a specific shard (i.e., node 150) of the distributed database 152. For example, each node 150 may be allocated or provisioned corresponding memory 154, 154a—n (i.e., a local cache 154) to cache writes to sections of the database 152 while each cache node 350 is allocated or provisioned memory 354, 354a—n as part of the distributed cache pool 300 for reading data from the database. Write cache for a particular shard of the distributed database 152 is stored on the memory 154 of the respective node 150 while read cache (which does not need a single authoritative source) may be included on any one or more (e.g., via replication) of the cache nodes 350.

The nodes 150 may operate conventionally using the local cache 154 to govern writes (e.g., memtables and/or logs) to the corresponding shard of the distributed database 152. However, each node 150 may rely on the distributed cache pool 300 to access cached data for reads. Data from any shard of the distributed database 152 may be cached in the distributed cache pool 300, where the respective corresponding node 150 and/or the user 12 can access the data of the shard (i.e., cache new data and read cached data). In other words, the distributed cache pool 300 does not belong to a specific section of the distributed database 152 or a specific node 150 but instead represents a pool available for each of the nodes 150 to cache data of the distributed database 152 for reads. In some implementations, when a user 12 requests data be read from a specific section of the distributed database 152, the corresponding node 150 (i.e., the node responsible for writes to that section of the distributed database 152) determines whether the data is available in the distributed cache pool 300 and retrieves the data for the user 12. In other implementations, the user 12 (via the user device 10) directly retrieves the data from the distributed cache pool 300 (e.g., via a remote direct memory access) and the nodes 150 are completely bypassed for at least some reads.

The remote system 140 executes a database manager 160 that includes, for example, an authoritative manager 170 and a map manager 180 to manage received queries 20, 30. The authoritative manager 170 may determine whether a user 12 has access to the distributed database 152 and/or the distributed cache pool 300. That is, when a query 20, 30 is received at database manager 160, authoritative manager 170 may determine whether the user 12 or user device 10 that issued the query 20, 30 should be authorized to access the distributed database 152 to write and/or read the data corresponding to the query 20, 30. The map manager 180 maintains and/or generates an access map 185 which maps locations of data in the distributed database 152 and/or distributed cache pool 300 (i.e., which cache nodes 350 include which data of the distributed database 152). The access map 185 may be a hashmap mapping locations of data in the distributed database 152 and or distributed cache pool 300. Though not illustrated, the map manager 180 may distribute the access map 185 to the user devices 10 and/or nodes 150. For example, a first node 150a may use the access map 185 to retrieve data from the distributed cache pool 300 that has been requested via a read query 30. If the first node 150a fails for any reason, the map manager 180 may transmit the access map 185 to a new node 150b to replace the failed node 150a. In some implementations, the user device 10 uses the access map 185 to directly fetch read data 40 from distributed cache pool 300. In some implementations, the remote system 140 implements remote direct memory access (RDMA) or an equivalent to allow the user device 10 to retrieve read data 40 from distributed cache pool 300 without involving the nodes 150.

The above examples are not intended to be limiting, and any number of nodes 150 and cache nodes 350 may be included within the remote system 140 and/or communicatively coupled to the distributed database 152 and distributed cache pool 300. Further, the distributed cache pool 300 may be of any suitable architecture and may include suitable memory such as random access memory (RAM) or solid state drives (SSD) or some combination thereof. Further, as the distributed cache pool 300 is not implemented locally on the nodes 150, the nodes 150 may access the distributed cache pool 300 through any known or suitable network, such as a fast network stack to maintain speed and efficiency. By leveraging the distributed cache pool 300, the remote system 140 may greatly reduce the overprovisioning conventionally necessary for the nodes 150, make sure of different tiers of memory (e.g., RAM, SSDs, etc.), and/or remove nodes 150 (i.e., tablet servers) from the read path of at least some reads of the distributed database 152.

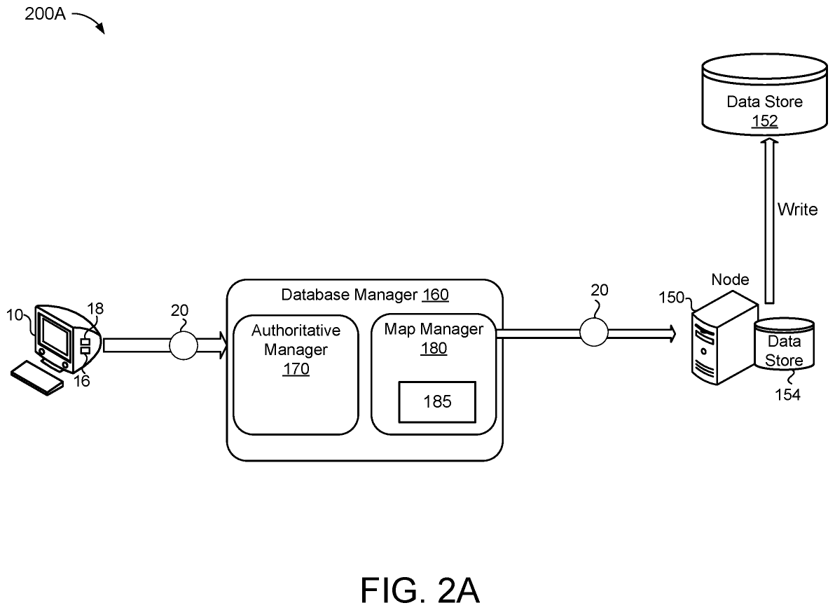

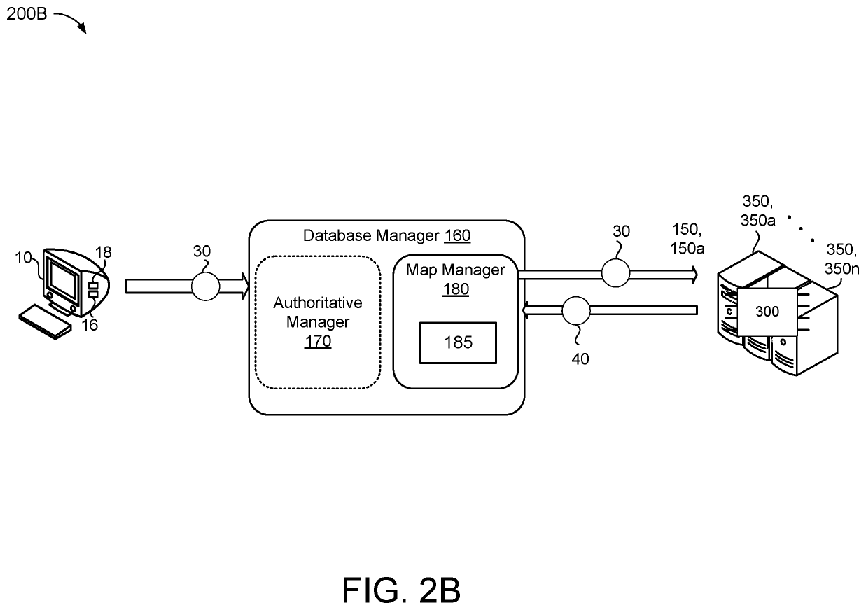

Referring now to FIG. 2A, a schematic view 200A includes a write query 20 (i.e., from the user device 10) requesting data 22 be written to the distributed database 152. The database manager 160 receives the write query 20 and the authoritative manager 170 may determine whether the user device 10 has authority to write to the distributed database 152. The authoritative manager 170 may deny the write query 20 when the user device 10 and/or user 12 issuing the write query 20 are not authorized. When the write query 20 is authorized, the database manager 160 may transmit the write query 20 to the one or more respective nodes 150 responsible for writing the data 22. For example, the database manager 160 divides the write query 20 into a number of sub-queries such that each sub-query only writes data that a single node 150 is responsible for. In some examples, the database manager 160 or the nodes 150 cache the write data 22 to the distributed cache pool 300. In these implementations, the map manager 180 may update the access map 185 to add the new data 22 to the access map 185 (i.e., map the locations of the newly written data).

In some implementations, the node 150 writes the data 22 directly to the distributed database 152. In other implementations, the node 150 writes the data 22 of the write query 20 to a memtable stored in memory 154, which is then “flushed” or written to the distributed database 152 at a later time. In some implementations, the node 150 writes the data 22 to the memory 154. Alternatively or additionally, the node 150 writes the data 22 to the distributed cache pool 300.

Referring now to FIG. 2B, a schematic view 200B includes a read query 30 (i.e., from the user device) requesting data 40 be read from the distributed database 152. The database manager 160 receives the read query 30 and the authoritative manager 170 may determine whether the user device 10 issuing the read query 30 has authority to read from the distributed database 152 or read the requested data 40 from the distributed database 152. In some implementations, the read query 30 is transmitted (e.g., by the user device 10) directly to the map manager 180 without determining authorization at the authoritative manager 170. The authoritative manager 170 may deny the read query 30 when the user device 10 issuing the read query 30 is not authorized. When the read query 30 is authorized, the map manager 180 may use the access map 185 to determine whether and/or where the requested data 40 resides within the distributed cache pool 300. For example, the map manager 180 determines that the read query 30 requests particular data 40 to be read from the distributed database 152.

The map manager 180 may determine, using the access map 185, the location of the requested data in the distributed cache pool 300. In some implementations, the user device 10 uses the access map 185 to directly or indirectly read or fetch the requested data 40 from the distributed cache pool 300. In other implementations, the database manager 160 sends the read query 30 (or sub-queries) to the nodes 150 responsible for the respective portions of the database 152 and the nodes 150 in turn, using the access map 185, fetch the requested data 40 from the distributed cache pool 300 to satisfy the read query 30. In some examples, the database manager and/or the nodes 150 update the distributed cache pool 300 (i.e., the data stored in the distributed cache pool 300) based on the read query 30. In these examples, the database manager 160 and/or the nodes 150 update the access map 185 accordingly to reflect the updated distributed cache pool 300.

In some implementations, the user device 10 accesses or retrieves the access map 185 to determine which cache node 350 the desired data resides upon. In these implementations, the map manager 180 distributes the access map 185 to the user device 10 prior to or in response to the read query 30. The user device 10 may, using the access map 185 and the cache node 350 (i.e., the distributed cache pool 300), directly retrieve the read data 40. In some implementations, the user device 10 relies on the database manager 160 and/or the nodes 150 to retrieve the read data 40 when the read data 40 is not available in the distributed cache pool 300 (i.e., the read data 40 is not cached and instead must be fetched from the distributed database 152).

In some implementations, the database manager 160 forwards the read query 30 and/or access map 185 to the appropriate cache node 350. The node 150 may perform the query by reading the read data 40 from the distributed cache pool 300 and/or the database 152 (e.g., when the data is not available in the distributed cache pool 300) and transmitting the read data 40 back to the user device 10. For example, when the access map 185 is a hashmap, the node 150 retrieves the read data 40 based on the hashmap mapping locations of the read data 40 in the distributed database 152 and/or the distributed cache pool 300. In some implementations, the node 150 reads the read data 40 directly from the distributed database 152. In other implementations, the node 150 reads the read data 40 of the read query 30 from a memtable, which includes data that has not yet been committed to the distributed database 152. In some implementations, the node 150 reads the read data 40 from local cache or local memory 154. Alternatively, the node 150 may read the read data 40 from the distributed cache pool 300. The user device 10 and/or the node 150 may read the read data 40 from any of the distributed database 152, the local cache 154, and/or the distributed cache pool 300 using any suitable techniques, such as remote direct memory access.

Referring now to FIG. 3, an exemplary distributed cache pool 300 includes multiple different types of memory, such as RAM 310 and SSDs 320 (or other types of volatile and nonvolatile memories). The RAM 310 may include suitable data structures, such as row cache, block cache, etc. The data stored in the distributed cache pool 300 may be tiered such that a first portion of data is stored on RAM 310 and a second portion is stored on SSDs 320. As RAM 310 typically accesses data faster than the SSDs 320, the cache nodes 350 and/or database manager 160, in some examples, store the portion of data corresponding to the most frequently used and/or more recently used data in the RAM 310, and the second portion of data corresponding to older or less frequently used data in the SSD 320.

In some implementations, other memory devices (not shown) are included in the distributed cache pool 300. In cloud computing, solid-state storage is generally cheaper than RAM storage and can be sufficiently fast in certain implementations. However, SSDs 320 are commonly not cost effective to implement at small sizes (e.g., below 16 GB), as the storage size is not with the effort in maintaining a separate repository. This contrasts with a desire to keep the portions of the database 152 that each node 150 governs small (e.g., 16 GB or less) so that a failure of a node 150 is less disruptive for database access. Here, because the distributed cache pool 300 is much larger than a typical memory cache associated with a node 150 (e.g., memory 154), the remote system 140 may leverage SSD memory 320 in the distributed cache pool 300 (e.g., the distributed cache pool 300 can be 448 GB, with 64 GB of RAM 310 and 384 GB of SSD 320) which reduces cost and resources while maintaining nearly identical access times.

In some examples, the nodes 150 are communicatively coupled to the distributed cache pool 300. When looking for data, each node 150 may first search local memory 154. If the node 150 cannot find data at the local memory 154, the node 150 may use the access map 185 and/or access the distributed cache pool 300 to determine which data is cached. For example, the node 150 uses a remote direct memory access to retrieve data from distributed cache pool 300. When the data is not available in the distributed cache pool 300, the node 150 may then retrieve the data from the distributed database 152.

Thus, implementations herein include a database manager that disaggregates cache memory to increase efficiency of distributed databases. Conventional shared databases have varying cache needs for nodes, but the nodes are provisioned uniformly. More specifically, each node is provisioned for peak load, even if the node rarely (if ever) reaches such load. Therefore, there typically is a considerable pool of underutilized cache RAM. The database manager, in some implementations, moves RAM cache to a centralized elastically managed service and communicates with the cache over a fast network stack, allowing for speeds comparable to local RAM. The device manager allows for reduced RAM at the nodes as each node does not need to be provisioned for peak, which saves resources. The database manager may also move some cache storage onto, for example, local non-volatile memory (e.g., solid-state drives, non-volatile memory express (NVMe), etc.) and far memory devices. Because the cache service can have larger chunks, such categorization is possible. Local non-volatile memory often has a considerably lower price than RAM (e.g., up to twenty times cheaper) while still having fast enough access times for cold cached data.

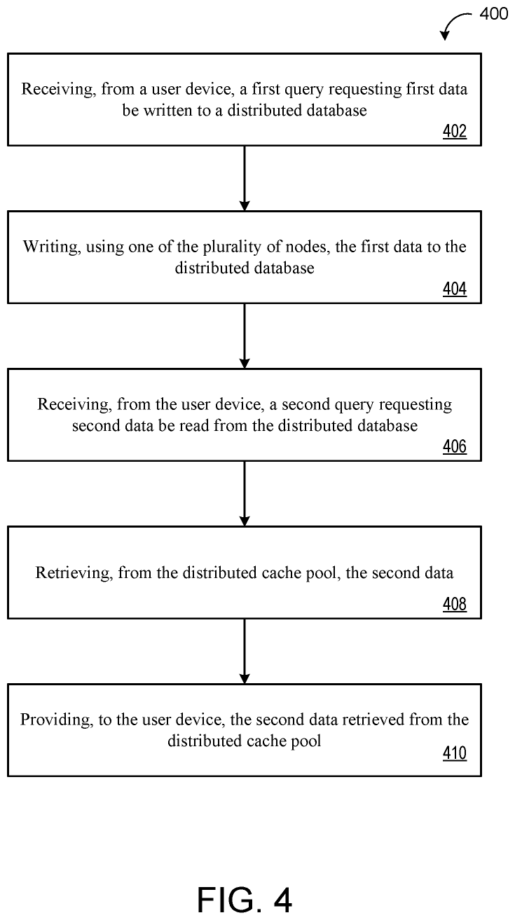

FIG. 4 is a flowchart of an exemplary arrangement of operations for a method 400 for disaggregated cache memory for efficiency in distributed databases. The method 400 may be performed by various elements of the system 100 of FIG. 1 and/or the computing device 500 of FIG. At operation 402, the method 400 includes receiving, from a user device 10, a first query 20 requesting first data 22 be written to a distributed database 152. The distributed database 152 includes a plurality of nodes 150, 150a—n, each respective node 150 of the plurality of nodes 150 controlling writes to a respective portion of the distributed database 152 and a distributed cache pool 300, the distributed cache pool 300 caching a subset of the distributed database 152 independently from the plurality of nodes 150. At operation 404, the method 400 includes writing, using one of the plurality of nodes 150, the first data 22 to the distributed database 152. At operation 406, the method 400 includes receiving, from the user device 10, a second query 30 requesting second data be read from the distributed database 152. At operation 408, the method 400 further includes retrieving, from the distributed cache pool 300, the second data. At operation 410, the method includes providing, to the user device 10, the second data retrieved from the distributed cache pool 300.

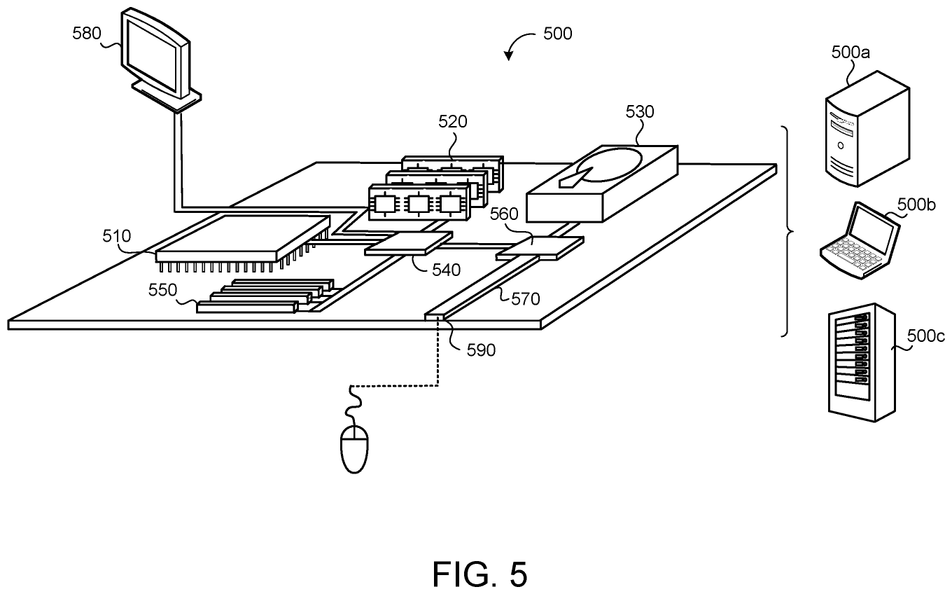

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware that causes the data processing hardware to perform operations comprising:
receiving, from a user device, a first query requesting first data be written to a distributed database, the distributed database comprising:
a plurality of nodes, each respective node of the plurality of nodes controlling writes to a respective portion of the distributed database; and
a distributed cache pool, the distributed cache pool caching a subset of the distributed database independently from the plurality of nodes;
writing, using one of the plurality of nodes, the first data to the distributed database;
receiving, from the user device, a second query requesting second data be read from the distributed database;
retrieving, from the distributed cache pool, the second data; and
providing, to the user device, the second data retrieved from the distributed cache pool.

2. The method of claim 1, wherein the distributed cache pool comprises distributed memory of a second plurality of nodes, each node in the second plurality of nodes different from each node in the plurality of nodes.

3. The method of claim 2, wherein the distributed cache pool comprises:
a first portion distributed across random access memory (RAM) of the second plurality of nodes; and
a second portion distributed across solid state drives (SSDs) of the second plurality of nodes.

4. The method of claim 1, wherein the operations further comprise:
generating an access map mapping locations of data in the distributed cache pool; and
distributing the access map to each node of the plurality of nodes.

5. The method of claim 4, wherein, after receiving the first query, the operations further comprise determining, by at least one of the plurality of nodes, using the access map, the location of the first data in the distributed cache pool.

6. The method of claim 1, wherein the operations further comprise:
generating an access map mapping locations of data in the distributed cache pool; and
distributing the access map to the user device.

7. The method of claim 6, wherein the second query comprises a location of the second data in the distributed cache pool based on the access map.

8. The method of claim 1, wherein retrieving, from the distributed cache pool, the second data is based on a hashmap mapping locations of data in the distributed cache pool.

9. The method of claim 1, wherein retrieving, from the distributed cache pool, the second data comprises using a remote direct memory access.

10. The method of claim 1, wherein the distributed cache pool comprises row cache and block cache.

11. A system comprising:
data processing hardware; and
memory hardware in communication with the data processing hardware, the memory hardware storing instructions that when executed on the data processing hardware cause the data processing hardware to perform operations comprising:
receiving, from a user device, a first query requesting first data be written to a distributed database, the distributed database comprising:
a plurality of nodes, each respective node of the plurality of nodes controlling writes to a respective portion of the distributed database; and
a distributed cache pool, the distributed cache pool caching a subset of the distributed database independently from the plurality of nodes;
writing, using one of the plurality of nodes, the first data to the distributed database;
receiving, from the user device, a second query requesting second data be read from the distributed database;
retrieving, from the distributed cache pool, the second data; and
providing, to the user device, the second data retrieved from the distributed cache pool.

12. The system of claim 11, wherein the distributed cache pool comprises distributed memory of a second plurality of nodes, each node in the second plurality of nodes different from each node in the plurality of nodes.

13. The system of claim 12, wherein the distributed cache pool comprises:
a first portion distributed across random access memory (RAM) of the second plurality of nodes; and
a second portion distributed across solid state drives (SSDs) of the second plurality of nodes.

14. The system of claim 11, wherein the operations further comprise:
generating an access map mapping locations of data in the distributed cache pool; and
distributing the access map to each node of the plurality of nodes.

15. The system of claim 14, wherein, after receiving the first query, the operations further comprise determining, by at least one of the plurality of nodes, using the access map, the location of the first data in the distributed cache pool.

16. The system of claim 11, wherein the operations further comprise:
generating an access map mapping locations of data in the distributed cache pool; and
distributing the access map to the user device.

17. The system of claim 16, wherein the second query comprises a location of the second data in the distributed cache pool based on the access map.

18. The system of claim 11, wherein retrieving, from the distributed cache pool, the second data is based on a hashmap mapping locations of data in the distributed cache pool.

19. The system of claim 11, wherein retrieving, from the distributed cache pool, the second data comprises using a remote direct memory access.

20. The system of claim 11, wherein the distributed cache pool comprises row cache and block cache.
